(19) United States
(12) Patent Application Publication
(10) Pub. No.: US 2018/0178874 A1
(43) Pub. Date: Jun. 28, 2018

(54) INTELLIGENT COMPONENT AND BICYCLE

(71) Applicants: Le Holdings (Beijing) Co., Ltd., Beijing (CN); LETV SPORTS CULTURE DEVELOP (Beijing) Co., Ltd., Beijing (CN)

(72) Inventor: Dalong Li, Beijing (CN)

(21) Appl. No.: 15/117,357

(22) PCT Filed: May 13, 2016
(86) PCT No.: PCT/CN2016/081966

§ 371 Date: Aug. 8, 2016

(30) Foreign Application Priority Data
Aug. 11, 2015 (CN) 201510491369.1

(51) Int. Cl. B62K 21/18; B62K 21/12; B62J 99/00

(52) U.S. Cl. CPC B62K 21/18; B62K 21/12; B62J 2099/004; B62J 2099/0033; B62J 99/00

(57) ABSTRACT

The application provides an intelligent component and a bicycle. The intelligent component includes a bracket, and an intelligent component body embedded on the bracket, wherein the bracket is connected with a handle bar of a bicycle, and a frame of the bicycle. In the technical solution according to the application, the intelligent component body is embedded on the bracket, and the handle bar and the frame are connected by the intelligent component, so that the bicycle is structurally compact and aesthetically pleasing; and the intelligent component is added to the bicycle so that music playing, navigation, bicycle management, and other operations can be performed by operating on a screen of the intelligent component to thereby facilitate smart control on the bicycle.

This application is a US National Stage of International Application PCT/CN2016/081966, filed on May 13, 2016, designating the United States, and claiming the benefit of Chinese Patent Application No. 201510491369.1, filed with the Chinese Patent Office on Aug. 11, 2015 and entitled “Intelligent component and bicycle”, which is hereby incorporated by reference in its entirety.

### TECHNICAL FIELD

The present application relates to the field of bicycles, and particularly to an intelligent component and a bicycle.

### BACKGROUND

A bicycle today has been used as more than transportation means, and people have increasingly preferred to their exercises in an environmentally friendly manner as the level of life has been increasingly growing, so the bicycle has become popular exercise means in environmentally friendly sporting in response to this demand.

At present, if riding users need to operate an electronic device, e.g., a navigation, an MP3 player, etc., then firstly a bracket will be fixed on a handle bar of the bicycle, and then the electronic device will be fixed on the bracket, so that the electronic device can be installed and fixed on the bicycle. However this fixing may be neither firm nor aesthetically pleasing; and since the electronic device is uncontrollably connected with the bicycle, the bicycle cannot be controlled smartly.

### SUMMARY

Embodiments of the application provide an intelligent component and a bicycle so as to smartly control the bicycle which is structurally compact and aesthetically pleasing.

An embodiment of the application provides an intelligent component including a bracket, and an intelligent component body embedded on the bracket, wherein the bracket is connected with a handle bar of a bicycle, and a frame of the bicycle.

In the technical solution according to the application, the intelligent component body is embedded on the bracket, and the handle bar and the frame are connected by the intelligent component, so that the bicycle is structurally compact and aesthetically pleasing; and the intelligent component is added to the bicycle so that music playing, navigation, bicycle management, and other operations can be performed by operating on a screen of the intelligent component to thereby facilitate smart control on the bicycle.

An embodiment of the application further provides a bicycle including a frame and a handle bar, and the intelligent component according to any one of the technical solutions above. The bicycle can be structurally compact and aesthetically pleasing, and also can be controlled smartly.

### BRIEF DESCRIPTION OF THE DRAWINGS

In order to make the technical solutions according to the embodiments of the application or in the prior art more apparent, the drawings to which a description of the embodiments or the prior art refers will be briefly introduced below, and apparently the drawings to be described below are merely illustrative of some of the embodiments of the application, and those skilled in the art can derive from these drawings other drawings without any inventive effort. In the drawings:

FIG. 1 is a schematic explosive structural diagram of an intelligent component according to an embodiment of the application;

FIG. 2 is a schematic stereo structural diagram of diagram of an intelligent component according to an embodiment of the application;

FIG. 3 is a schematic stereo structural diagram of diagram of an intelligent component according to an embodiment of the application;

FIG. 4 is a schematic diagram of an intelligent component connected with a handle bar according to an embodiment of the application; and

FIG. 5 is a schematic diagram of an intelligent component connected with a frame according to an embodiment of the application.

### REFERENCE NUMERALS

100—Intelligent component
110—Bracket
120—Intelligent component body
200—Handle bar
300—Frame
111—First installation hole
112—First notch
113—Second installation hole
114—Second notch
115—Ear plate
116—First section
117—Second section
118—Weight-reducing hole
121—Lower casing
122—Circuit board and battery
123—Upper casing
124—Display screen
125—Touch screen

### DESCRIPTION OF THE EMBODIMENTS

In order to make the objects, technical solutions, and advantages of the embodiments of the application more apparent, the technical solutions according to the embodiments of the application will be described below clearly and fully with reference to the drawings in the embodiments of the application, and apparently the embodiments described below are only a part but not all of the embodiments of the application. Based upon the embodiments here of the application, all the other embodiments which can occur to those skilled in the art without any inventive effort shall fall into the scope of the application.

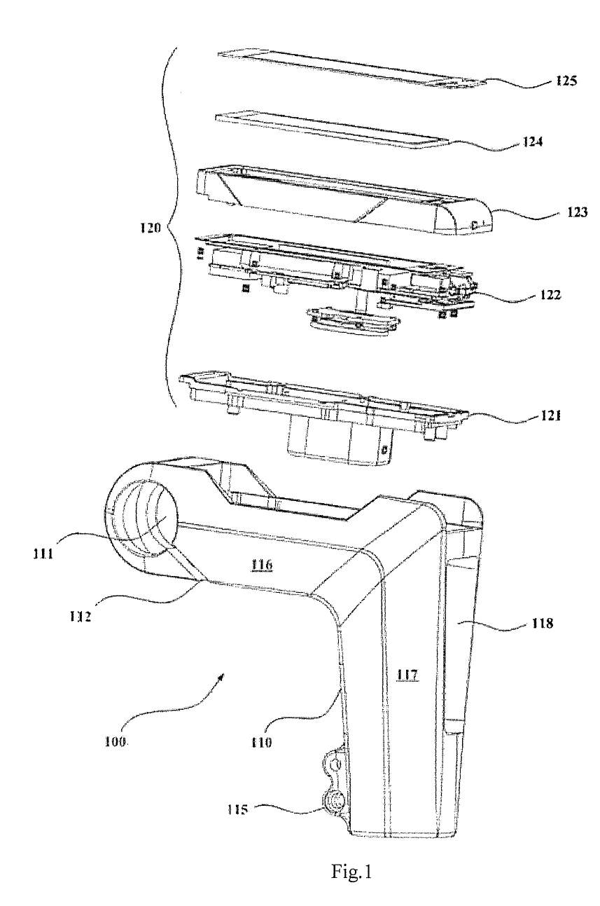

As illustrated in FIG. 1 to FIG. 5, an intelligent component 100 according to an embodiment of the application includes a bracket 110, and an intelligent component body 120 embedded on the bracket 110, where the bracket 110 is connected between a handle bar 200 of a bicycle, and a frame 300 of the bicycle.

The bracket 110 will not be limited to any particular shape, but can be designed dependent upon particular structural shapes of the handle bar 200 and the frame 300 of the bicycle. As illustrated in FIG. 1, in this embodiment, the bracket 110 includes a first section 116 and a second section 117 between which there is a preset angle, where the first section 116 is connected with the handle bar, the second section 117 is connected with the frame, and the intelligent component body 120 is embedded on the upper surface of the first section 116. The bracket 110 is preferably made of highly rigid metal or carbonized steel, so that the handle bar and the frame can be connected by the bracket 110 reliably in structural rigidness.

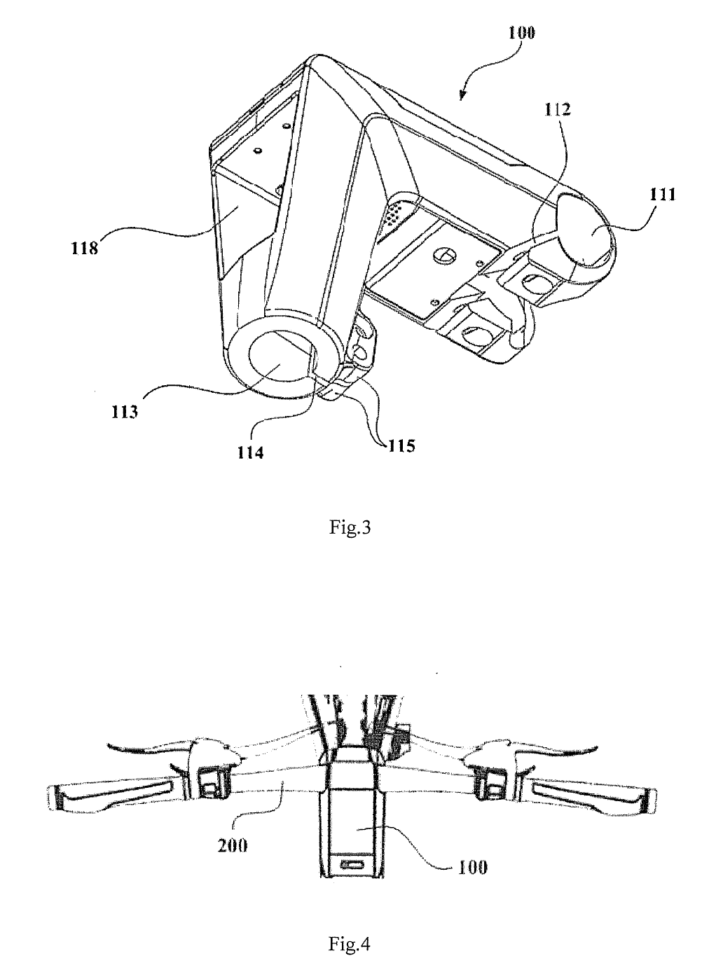

As illustrated in FIG. 1 and FIG. 3, the second section 117 includes a weight-reducing hole 118 opened in the traveling direction of the bicycle. The weight-reducing hole 118 can reduce the weight of the bracket 110 and further the weight of the bicycle; and additionally the weight-reducing hole 118 opened in the traveling direction of the bicycle can reduce the resistance to a bicycler so that the bicycler will save his more effort and feel easier.

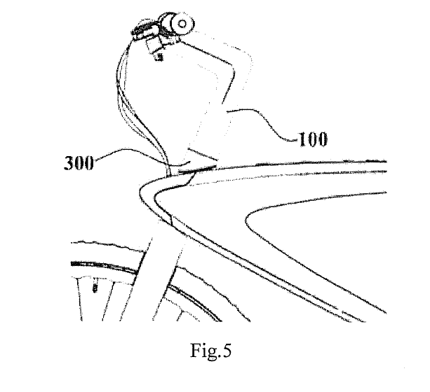

The handle bar and the frame can be connected with the bracket 110 in any particular structure as appropriate, and as illustrated in FIG. 1, FIG. 3, FIG. 4 and FIG. 5, the bracket 110 includes a first installation hole 111 sleeved on the handle bar 200, and a first notch 112 leading to the first installation hole 111, where both sides of the first notch 112 are fastened to each other by a fastener (e.g., a bolt can be used and is not illustrated); and the bracket 110 also includes a second installation hole 113 sleeved on the frame 300, and a second notch 114 leading to the second installation hole 113, where both sides of the second notch 114 are fastened to each other by a fastener. Particularly the second notch 114 includes ear plates 115 arranged opposite to each other on both of the sides of the second notch 114, where the ear plates 115 arranged opposite to each other are fastened to each other by a fastener (e.g., a bolt component can be used and is not illustrated). In this way, the handle bar 200 and the frame 300 can be connected reliably with the bracket 110, and they can be assembled conveniently, thus improving the efficiency of assembling them; and the intelligent component here can be integral to the bicycle to thereby make the bicycle structurally compact and aesthetically pleasing.

The intelligent component body 120 is a key electronic device for the bicycle to be controlled smartly, where music playing, navigation, bicycle management, and other operations can be performed by operating on a screen of the intelligent component to thereby control the bicycle smartly. As illustrated in FIG. 1, the intelligent component body 120 includes a lower casing 121, a circuit board and battery 122, an upper casing 123, a display screen 124, and a touch screen 125 arranged in that order from the inside to the outside, where the lower casing 121 is connected with the bracket 110, the upper casing 123 is connected with the lower casing 121, and the circuit board and battery 122 is located in a holding space defined by the lower casing 121 and the upper casing 123; and the display screen 124 and the touch screen 125 are arranged on the outer surface of the upper casing 123.

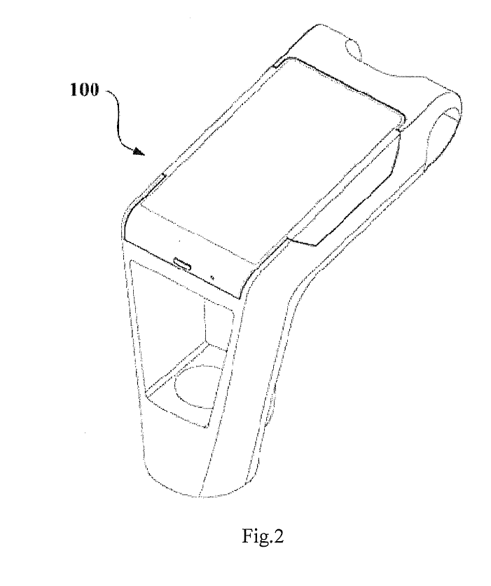

In a preferred embodiment of the application, as illustrated in FIG. 2, the upper casing 123 transitions smoothly to the surface of the bracket 110, so that the intelligent component 100 can be more aesthetically pleasing in appearance, and more pleasant while being touched.

In the technical solution according to the respective embodiments above of the application, the intelligent component body is embedded on the bracket, and the handle bar and the frame are connected by the intelligent component, so that the bicycle is structurally compact and aesthetically pleasing; and the intelligent component is added to the bicycle so) that music playing, navigation, bicycle management, and other operations can be performed by operating on the screen of the intelligent component to thereby facilitate smart control on the bicycle.

Referring to FIG. 4 and FIG. 5, an embodiment of the application further provides a bicycle including a frame 300 and a handle bar 200, and also the intelligent component 100 according to any one of the technical solutions above. The bicycle can be structurally compact and aesthetically pleasing, and also can be controlled smartly, thus resulting a good experience of its user.

Lastly it shall be noted that the respective embodiments above are merely intended to illustrate but not to limit the technical solution of the application; and although the application has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the application as claimed.

1. An intelligent component, comprising a bracket, and an intelligent component body embedded on the bracket, wherein the bracket is connected with a handle bar of a bicycle, and a frame of the bicycle.

2. The intelligent component according to claim 1, wherein:
the bracket comprises a first installation hole sleeved on the handle bar, and a first notch leading to the first installation hole, wherein both sides of the first notch are fastened to each other by a fastener; and
the bracket also comprises a second installation hole sleeved on the frame, and a second notch leading to the second installation hole, wherein both sides of the second notch are fastened to each other by a fastener.

3. The intelligent component according to claim 2, wherein the second notch comprises ear plates arranged opposite to each other on both of the sides of the second notch, and the ear plates arranged opposite to each other are fastened to each other by a fastener.

4. The intelligent component according to claim 1, wherein the bracket comprises a first section and a second section between which there is a preset angle, wherein the first section is connected with the handle bar, the second section is connected with the frame, and the intelligent component body is embedded on the upper surface of the first section.

5. The intelligent component according to claim 4, wherein the second section comprises a weight-reducing hole opened in the traveling direction of the bicycle.

6. The intelligent component according to claim 1, wherein the intelligent component body comprises a lower casing, a circuit board and battery, an upper casing, a display screen, and a touch screen arranged in that order from the inside to the outside, wherein:
the lower casing is connected with the bracket, the upper casing is connected with the lower casing, and the circuit board and battery is located in a holding space defined by the lower casing and the upper casing; and the display screen and the touch screen are arranged on the outer surface of the upper casing.

7. The intelligent component according to claim 6, wherein the upper casing transitions smoothly to the surface of the bracket.

8. A bicycle, comprising a frame, a handle bar, and an intelligent component; wherein the intelligent component comprise a bracket, and an intelligent component body embedded on the bracket, wherein the bracket is connected with the handle bar of the bicycle, and the frame of the bicycle.

9. The bicycle according to claim 8, wherein:
the bracket comprises a first installation hole sleeved on the handle bar, and a first notch leading to the first installation hole, wherein both sides of the first notch are fastened to each other by a fastener; and
the bracket also comprises a second installation hole sleeved on the frame, and a second notch leading to the second installation hole, wherein both sides of the second notch are fastened to each other by a fastener.

10. The bicycle according to claim 9, wherein the second notch comprises ear plates arranged opposite to each other on both of the sides of the second notch, and the ear plates arranged opposite to each other are fastened to each other by a fastener.

11. The bicycle according to claim 8, wherein the bracket comprises a first section and a second section between which there is a preset angle, wherein the first section is connected with the handle bar, the second section is connected with the frame, and the intelligent component body is embedded on the upper surface of the first section.

12. The bicycle according to claim 11, wherein the second section comprises a weight-reducing hole opened in the traveling direction of the bicycle.

13. The bicycle according to claim 8, wherein the intelligent component body comprises a lower casing, a circuit board and battery, an upper casing, a display screen, and a touch screen arranged in that order from the inside to the outside, wherein:
the lower casing is connected with the bracket, the upper casing is connected with the lower casing, and the circuit board and battery is located in a holding space defined by the lower casing and the upper casing; and the display screen and the touch screen are arranged on the outer surface of the upper casing.

14. The bicycle according to claim 13, wherein the upper casing transitions smoothly to the surface of the bracket.
